(19) United States
(12) Patent Application Publication
(10) Pub. No.: US 2005/0141949 A1
(43) Pub. Date: Jun. 30, 2005

(54) Ink marker bottle

(76) Inventor: John Calabro, Buffalo, NY (US)

Correspondence Address: JOHN CALABRO, SUITE 100, 275 NORTHPOINTE PARKWAY, AMHERST, NY, 14228, US

(21) Appl. No.: 11/024,586

(22) Filed: Dec. 29, 2004

Related U.S. Application Data
(60) Provisional application No. 60/533,568, filed on Dec. 31, 2003.

(51) Int. Cl. B43K 5/00; B43M 11/06

(52) U.S. Cl. 401/196; 401/6

(57) ABSTRACT

An ink marker bottle suitable for use as a marker for bingo cards comprises an elongated hollow body having a dauber at the top end and having a rectangular cross-sectional shape at the lower end to provide improved stability when the bottle is resting in an upright position. The elongated hollow body includes a central recessed portion that configured for ease of holding by the user.

### CROSS-REFERENCE TO RELATED PROVISIONAL APPLICATION

This application claims priority based on Provisional Patent Application Ser. No. 60/533,568 filed Dec. 31, 2003.

### BACKGROUND

This invention relates to devices for marking on surfaces and, in particular, to hand-held marking devices suitable for use in marking papers or cards, such as bingo cards or other game cards.

In the game of bingo, each player has a bingo card having printed thereon a number of squares arranged in rows and columns, typically numbering 25 squares arranged in five columns and five rows, with the columns being identified at the top by a letter and within the square by a number. As the game is played, a bingo caller calls out a number and the letter designating the column in which the number may be found. A player whose card contains a square that matches the number and column, records the call by marking or otherwise designating the square. Traditionally, the recording of a particular call was accomplished by covering the corresponding square with a small plastic or paper disc. More recently, it has become common practice to record or identify a square that has been called by placing an ink mark on the square, using an ink marking device, often referred to as a “bingo dabber” or “bingo marker”. Typically, such a bingo card marker is a hand held cylindrical plastic bottle, filled with a suitable marking ink and having a check-valve operated applicator head, generally of foam material. To record a called number, the user inverts the bottle and presses the head on the appropriate square. A spot of colored ink is transferred to the square. To keep up with the speed of the game, the marking procedure must be carried out rapidly and accurately. Thus the ease with which the player can manipulate the marking device is important.

A variety of bingo marker devices are in common use and are, in general, suitable for their intended purpose. However, it will be appreciated that improvements would be helpful with respect to such factors as cost of manufacture, ergonomic design, and ease of use.

U.S. Pat. No. 5,899,619 to O'Shei discloses a hand held marking device including two independent refillable ink reservoirs, for holding differently colored inks. Each reservoir is associated with separate depositing means or applicator head. The applicator heads are both at the same end of the marking device and are angled away from each other with a bumper extension therebetween to prevent both depositing means from simultaneously contacting the surface to be marked.

U.S. Pat. No. 4,863,171 to Rocheleau, discloses a bingo dabber for marking items such as bingo cards, the dabber being in the general form of a hammer with the head provided with two oppositely directed ink applicators.

U.S. Pat. No. 5,713,681 to Venne et al. discloses a bingo card marker bottle ergonomically designed for ease of holding during use. The bottle is of molded plastic and comprises an ink reservoir with an ink applicator mounted on the neck of the bottle.

In addition to liquid applicators such as those reference hereinabove, designed for use as marking devices, such as for use as bingo markers and the like, liquid applicators may be designed with a different flow-through of liquid, for such uses as shoe polish containers and/or applicators. Liquid containers and applicators which may be suitable for use in the polishing of shoes or for other purpose are known and are disclosed, for example, in patents, such as Design Patents 308,330 and 308,476.

Although the various bingo markers shown in the prior art are generally suitable for the intended use, it will be appreciated that a need exists for improvements in ergonomic design and ease of use are desirable.

It is therefore an object of the present invention to provide an ink marker bottle particularly suited for use in marking bingo cards.

It is a further object to provide an ink marker bottle characterized by ease of use.

It is a still further object to provide an ink marker bottle that is ergonomically designed to offer easier handling by the user.

It is a further object to provide an ink marker bottle having a more stable base to permit the bottle to be quickly and easily placed on a table in an upright position.

### SUMMARY OF THE INVENTION

The marker bottle of this invention is particularly suited for use as a marker for bingo cards as well as for other games. It is relatively inexpensive to manufacture and is characterized by ease of use.

The marker bottle comprises an elongated hollow body having an open top end, a closed bottom end, and a surrounding sidewall therebetween, defining a liquid reservoir.

The surrounding sidewall includes an upper shoulder portion, preferably of generally circular cross-sectional shape, an elongated central recessed portion having a generally oval or elliptical cross-sectional shape, flattened on two opposing sides, and a bottom sidewall or base portion having a polygonal cross-sectional shape and closed at the lower end by a bottom wall. For stability when standing in an upright position, the width of the base portion in all directions is preferably at least as great or greater than the width of the upper shoulder portion The elongated central recessed portion is configured for ease of holding by the user.

The top end of the marker bottle extends from the upper shoulder portion of the surrounding sidewall, is typically of circular cross-sectional shape, with a smaller radius than the shoulder portion and enclosing a liquid applicator means, such as a dauber. The top end may be adapted to receive a removable cap to serve as a cover over the dauber when it is not in use.

The elongated central recessed portion of the surrounding sidewall is configured to provide a convenient grip for the user.

The polygonal cross-sectional shape of the bottom portion provides a stable base that allows the marker bottle to rest on a table or other generally horizontal surface in an upright position when not in use. The stable base allows the user to set the bottle on a table quickly and easily during a game and for the bottle to rest there uncapped in an upright position with improved stability and lessened likelihood of falling over and accidentally marking a card or other nearby surface. In this position the marker bottle is ready for immediate use as the game continues. The stability may be further improved by providing added weight at the base, either inside or outside of the bottom wall. Thus, for example, a weight of higher density material, such as metal, may be secured to the inside or outside of the bottom wall or bottom sidewall by means of a suitable adhesive or other means.

In one embodiment, a free moving object, such as a ball bearing may be added to the liquid reservoir to aid in mixing of the liquid each time the ink marker bottle is inverted while marking a card or other surface The polygonal cross-sectional shape of the bottom portion is preferably in the form of a square. However, other rectangular shapes as well pentagonal, hexagonal or other polygonal shapes may be employed.

### BRIEF DESCRIPTION OF THE DRAWINGS

FIG. 1 is a perspective view of a preferred embodiment of the ink marker bottle of the present invention.

FIG. 2 is a cross-sectional view of the central recessed portion of the ink marker bottle of the present invention, taken along lines A-A of FIG. 1.

### DETAILED DESCRIPTION OF THE DRAWINGS

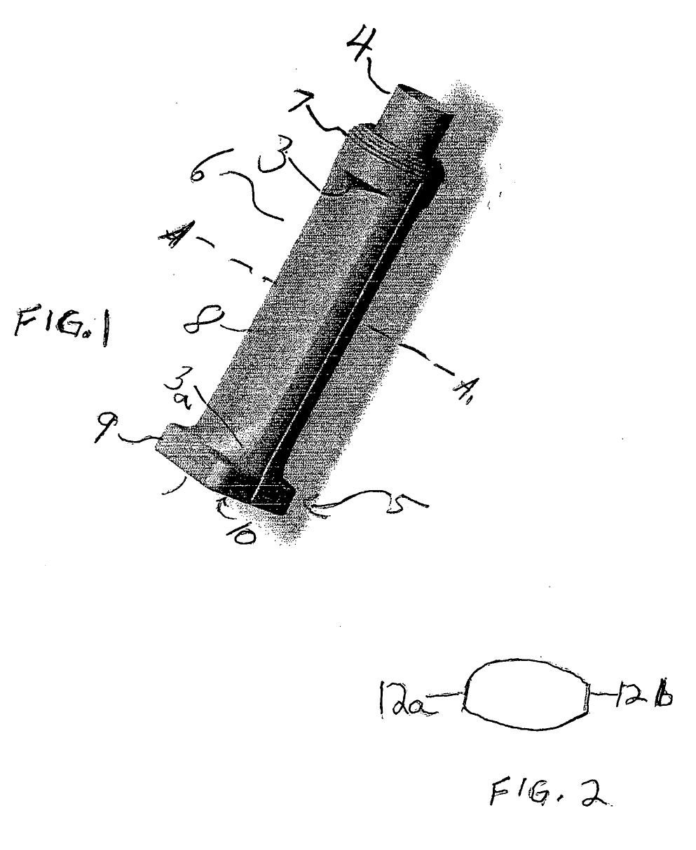

FIG. 1 sets forth a preferred embodiment of the ink marker bottle of the present invention comprising an elongated hollow body having an open top end 4, a closed bottom end 5, and a surrounding sidewall 6. The surrounding sidewall 6 includes an upper shoulder portion 7, preferably of generally circular cross-sectional shape, an elongated central recessed portion 8 having a generally oval cross-sectional shape with preferably having flattened sides 12 and 12a (as shown in FIG. 2), and a bottom sidewall portion 9 having a polygonal cross-sectional shape and closed at the lower end by a flat bottom wall 10. At each end of the central recessed portion 8, where the central recessed portion 8 joins the upper shoulder portion 7 at one end, and the bottom sidewall portion 9 at the other end, the surrounding sidewall 6 expands slightly to form diametrically opposing arcuate configurations 3 and 3a. Similar arcuate configurations are included on the opposite side of the bottle (not shown). The arcuate configurations 3 and 3a, together with the recessed, generally oval shape of the central recessed portion 8, provide an improved ergonomic configuration offering an easier grip for the user. The flat bottom wall 10 and the polygonal cross-sectional shape of the bottom sidewall portion 9 provide a stable base that allows the marker bottle to be conveniently placed on a table or other generally flat horizontal surface in an upright or vertical position when not in use. The top end 4 is configured to hold a dauber (not shown) for applying ink or other liquid to a surface such as a bingo card when the bottle is tipped and the dauber is pressed upon it. The dauber may be made in a manner known in the art, using felt, sponge, foam, or other suitable material sufficiently porous to become saturated with ink or other liquid to allow a transfer of the liquid to a surface when the dauber is pressed upon it. When not in use, the dauber may be covered by a cap (not shown). Typically the bottle may be manufactured of a suitable plastic material for example, by blow molding, injection molding, or other method known in the art.

Although the invention has been described with reference to certain preferred embodiments thereof, it will be appreciated that modifications and variations may be made without departing from the spirit and scope of the invention as defined in the appended claims.

1. An ink marker bottle comprising:
an elongated hollow body having an open top end, a closed bottom end, and a surrounding sidewall therebetween, said elongated hollow body defining a liquid reservoir;
said surrounding sidewall including an upper shoulder portion of generally circular cross-sectional shape extending from said top end and an elongated central recessed portion having a generally oval cross-sectional shape extending from said upper shoulder portion to a bottom sidewall portion having a polygonal cross-sectional shape and closed at a lower end by a bottom wall;
said central recessed portion including diametrically opposing arcuate configurations adjacent to said shoulder portion and said bottom sidewall portion.
Said generally oval cross-sectional shape of said elongated central recessed portion having a major diameter and a minor diameter, said minor diameter being less than the diameter of said upper shoulder portion.

2. An ink marker bottle according to claim 1 wherein said open top end of generally circular cross-section having a radius less than that of said upper shoulder portion.

3. An ink marker bottle according to claim 2 wherein said top open end houses a dauber capable of transferring ink from said liquid reservoir to a surface when said ink marker bottle is tipped and the dauber is pressed down on said surface.

4. An ink marker bottle according to claim 3 including a freely moving ball bearing within said liquid reservoir.

5. An ink marker bottle according to claim 3 wherein said polygonal cross-sectional shape is rectangular.

6. An ink marker bottle according to claim 5 wherein said polygonal cross-sectional shape is a square.

7. An ink marker bottle according to claim 3 wherein said polygonal cross-sectional shape is pentagonal.

8. An ink marker bottle according to claim 3 wherein said bottom sidewall portion includes a weight to provide added stability when said ink marker bottle is in an upright position with said bottom wall resting on a horizontal surface.

9. An ink marker bottle according to claim 8 wherein said weight is a metal weight secured to said bottom wall.
